(19) United States
(12) Patent Application Publication
(10) Pub. No.: US 2010/0248659 A1
(43) Pub. Date: Sep. 30, 2010

(54) WIRELESS COMMUNICATION DEVICE AND DIRECTIONAL ANTENNA CONTROL METHOD

(75) Inventor: Kazuo Kawabata, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/728,419

(22) Filed: Mar. 22, 2010

(30) Foreign Application Priority Data
Mar. 24, 2009 (JP) 2009-71932

(51) Int. Cl. H04B 17/00

(52) U.S. Cl. 455/115.1

(57) ABSTRACT

A wireless communication device includes a directional antenna that transmits radio signals, and an antenna control unit that measures, in a plurality of directions, spatial lengths from the wireless communication device to an object nearest the wireless communication device, and directs a directional antenna beam radiation direction toward a direction having the longest of the measured spatial lengths, when transmitting the radio signals.

### CROSS-REFERENCE TO RELATED APPLICATIONS

This application is based upon and claims the benefit of priority of the prior Japanese Patent Application No. 2009-71932, filed on Mar. 24, 2009, the entire contents of which are incorporated herein by reference.

### FIELD

The present invention relates to a wireless communication device that transmits radio signals using a directional antenna, and a directional antenna control method.

### BACKGROUND

In recent years, wireless LANs (WLANs: wireless local area networks) have been installed into offices of companies and homes. Also, installation of super-small “femto cell” base transceiver stations (femto BTSs) for a cellular system in homes is being considered. In such a wireless communication system, wireless communication devices, such as access points of wireless LANs or base station devices, may be installed in homes.

There is disclosed a communication system where a base station and a distant station include a first antenna array and a second antenna array, respectively. In this communication system, a signal transmitted from the first antenna array is received by the second antenna array so that array elements of the antenna arrays for establishing the optimum communication path are determined. (For example, see Japanese Laid-Open Patent Publication No. 8-265233.)

Users may install multiple wireless communication devices as described above in home without taking into account interference between signals transmitted from these devices. FIG. 1 is a diagram illustrating interference caused between wireless communication devices. In FIG. 1, reference numerals 1-1 and 1-2 represent wireless communication devices. Reference numerals 2-1 and 2-2 represent rooms where the wireless communication devices 1-1 and 1-2 are placed. Reference numerals 3-1 and 3-2 represent reach ranges of radio waves transmitted from the wireless communication devices 1-1 and 1-2.

The wireless communication devices 1-1 and 1-2 are disposed in adjacent rooms 2-1 and 2-2, respectively. Since the user has not taken into account the other wireless communication device disposed in the adjacent room in disposing one of the wireless communication devices 1-1 and 1-2, these wireless communication devices are disposed adjacent to each other with the wall therebetween. Thus, the reach ranges 1-1 and 1-2 of radio waves transmitted from the wireless communication devices 1-1 and 1-2 overlap each other. This causes interference between radio signals, deteriorating communication quality.

### SUMMARY

According to an aspect of the invention, a wireless communication device includes a directional antenna that transmits radio signals, and an antenna control unit that measures, in a plurality of directions, spatial lengths from the wireless communication device to an object nearest the wireless communication device, and directs a directional antenna beam radiation direction toward a direction having the longest of the measured spatial lengths, when transmitting the radio signals.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating interference caused between wireless communication devices.

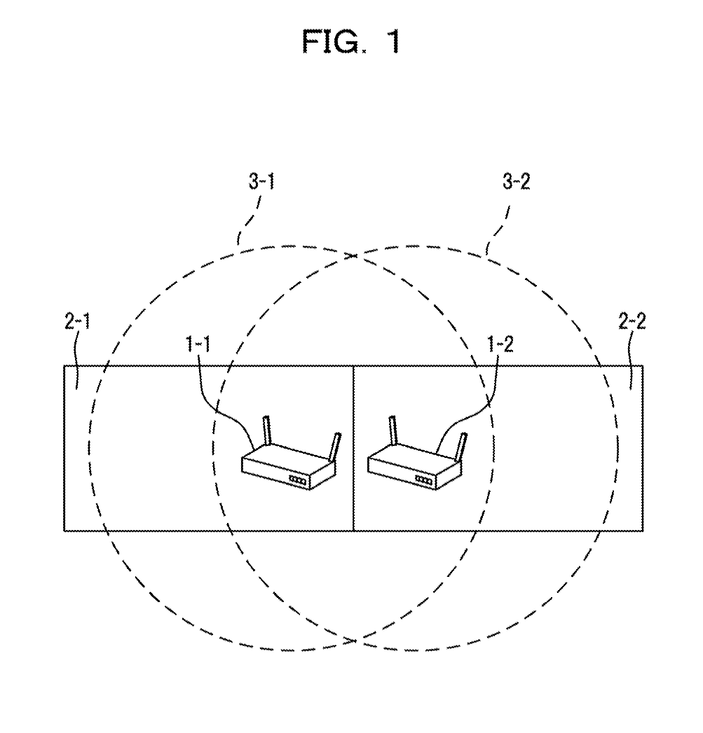

FIG. 2 is a diagram schematically illustrating a configuration of a wireless communication device according to a first embodiment.

FIG. 3 is a first example of the configuration of a measured value table.

FIG. 4 illustrates a first example process in a directional antenna control method.

FIG. 5 is a first example of a distance measurement process.

FIGS. 6A to 6D are first to fourth examples of a radiation direction determination process.

FIG. 7A is diagram illustrating an example of a pattern identification device.

FIG. 7B is a diagram illustrating an input signal thereof.

FIGS. 8A and 8B are diagrams illustrating a state where interference caused between wireless communication devices is reduced.

FIG. 9 is a diagram schematically illustrating a configuration of a wireless communication device according to a second embodiment.

FIG. 10 is a second example of the distance measurement process.

FIG. 11 is a second example configuration of the measured value table.

FIG. 12 illustrates a second example process in the directional antenna control method.

FIGS. 13A to 13C represent first to third examples of an antenna pattern determination process.

FIG. 14 is a diagram schematically illustrating a configuration of a wireless communication device according to a third embodiment.

FIG. 15 is a third example of the distance measurement process.

FIG. 16 is a fourth example of the distance measurement process.

FIG. 17 is a third example configuration of the measured value table.

FIGS. 18A and 18B are fifth and sixth examples of the radiation direction determination process.

### DESCRIPTION OF EMBODIMENTS

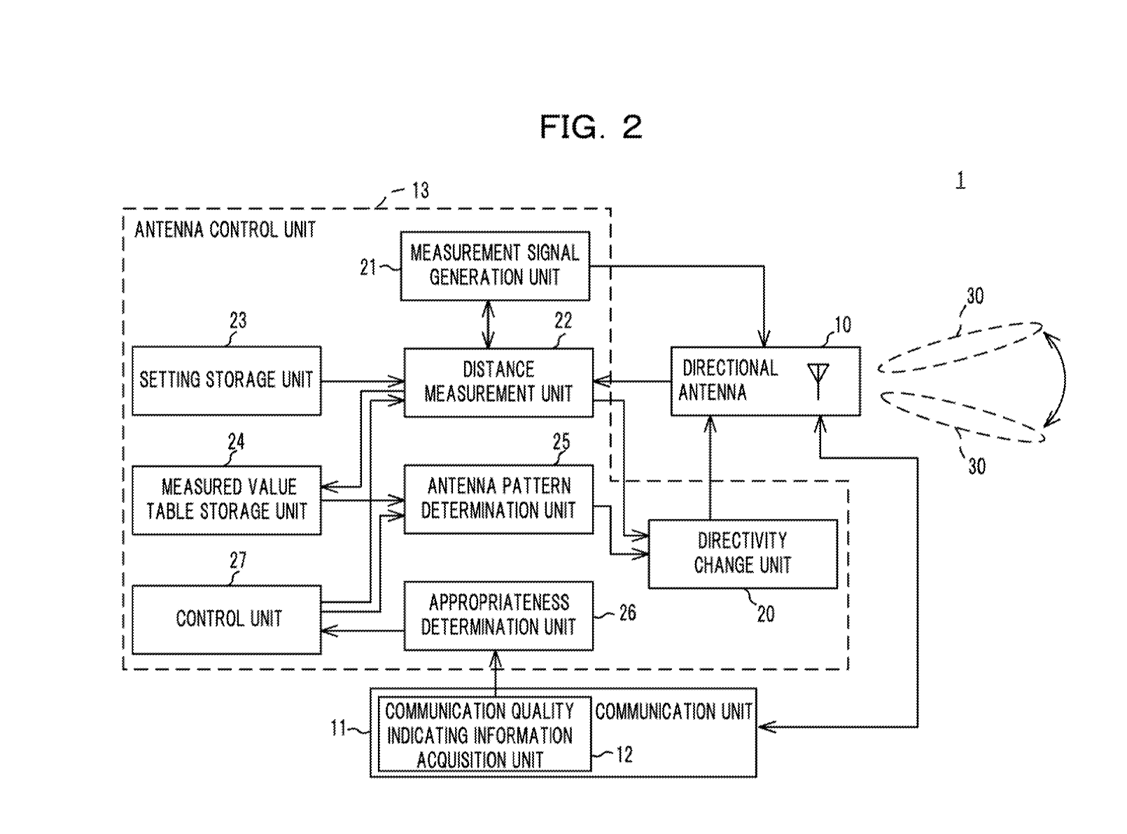

Now, embodiments of the present invention will be described with reference to the accompanying drawings. FIG. 2 is a diagram schematically illustrating a configuration of a wireless communication device according to a first embodiment.

The wireless communication device 1 may be, for example, a wireless LAN access point, a super-small base transceiver station for a femto cell, or a base transceiver station of worldwide interoperability for microwave access such as WiMAX. The wireless communication device 1 includes a directional antenna 10, a communication unit 11, a communication quality indicating information acquisition unit 12, and an antenna control unit 13. Reference numeral 30 represents an antenna pattern of the directional antenna 10, and radio waves are radiated according to the antenna pattern.

The communication unit 11 performs wireless communications by transmitting radio signals using the directional antenna 10. The directional antenna 10 radiates radio beams that transmit transmission signals transmitted by the communication unit 11.

The communication unit 11 includes the communication quality indicating information acquisition unit 12. The communication quality indicating information acquisition unit 12 acquires communication quality indicating information indicating the communication quality of a wireless communication performed by the communication unit 11 using the directional antenna 10. For example, communication quality indicating information may be generated by a counterpart device (not illustrated) with which the wireless communication device 1 communicates wirelessly. Upon receipt of a radio signal transmitted by the directional antenna 10, the counterpart device determines communication quality, based on the quality of the received radio wave, and generates communication quality indicating information. The communication quality indicating information acquisition unit 12 extracts the communication quality indicating information from a reception signal that is transmitted by the counterpart device and received by the communication unit 11, and outputs the extracted information to an appropriateness determination unit 26.

The antenna control unit 13 controls the directivity of the directional antenna 10 to be used when the wireless communication device 1 performs a wireless communication, that is, the radiation direction of radio beams for transmitting transmission signals. The antenna control unit 13 includes a directivity change unit 20, a measurement signal generation unit 21, a distance measuring unit 22, a setting storage unit 23, a measured value table storage unit 24, an antenna pattern determination unit 25, the appropriateness determination unit 26, and a control unit 27.

The directivity change unit 20 changes the directivity of the directional antenna 10, that is, the maximum radiation direction of radio beams radiated from the directional antenna 10. The directivity change unit 20 may change the maximum radiation direction of beams, for example, by physically changing the posture of the directional antenna. In a case where the directional antenna 10 includes a plurality of antenna elements, the directivity change unit 20 may change the maximum radiation direction of beams radiated from the directional antenna 10, for example, by adjusting the phases of signals radiated from the antenna elements. In the following description, the maximum radiation direction of beams may be referred to as the “beam radiation direction.”

In the following description, a “change in antenna pattern” refers to a change in radiation direction of radio beams radiated from the directional antenna 10. Accordingly, “a change in antenna pattern” indicates not only that a change in radiation direction of radio beams radiated from the directional antenna 10 may involve a change in pattern shape, but also that the radiation direction may be changed without causing a change in pattern shape.

Also, “antenna patterns are different” indicates that the radiation directions of beams radiated from the directional antenna 10 are different. Accordingly, “antenna patterns are different” indicates not only that the pattern shapes and radiation directions of radio beams radiated from the directional antenna 10 may be different, but also that the radiation directions may be different while the pattern shapes may not be different.

The measurement signal generation unit 21 provides measurement signals to the directional antenna 10 in order to measure the reflection times of radio waves that the directional antenna 10 radiates. Such measurement signals may be dedicated training signals or may be notification channel signals to be transmitted to any number of wireless communication devices. In a case where the measurement signals are notification channel signals, the measurement signal generation unit 21 may be a part of the communication unit 11.

The distance measuring unit 22 measures the distance from the wireless communication device 1 to an object nearest the wireless communication device 1 in the radiation direction of a measurement signal radiated by the directional antenna 10, based on the reflection time of the measurement signal, that is, based on the time over which the measurement signal is radiated, reflected by the nearest object, and returns to the directional antenna 10. Since the reflection time itself is proportionate to the distance to the nearest object, the distance measuring unit 22 may measure the reflection time and handle the reflection time itself as information indicating the distance.

The setting storage unit 23 stores the settings of different antenna patterns to be used when the distance measuring unit 22 performs the above-mentioned measurement in a plurality of measurement directions. The settings of a plurality of antenna patterns may include information indicating the above-mentioned plurality of measurement directions. Also, the settings of a plurality of antenna patterns may include parameters that the directivity change unit 20 uses in order to change the beam radiation direction to the above-mentioned plurality of measurement directions. The settings of antenna patterns may be stored in the setting storage unit 23 before shipping the wireless communication device 1. Alternatively, the settings of antenna patterns may be performed from the outside by connecting the shipped wireless communication device 1 to the Internet or a personal computer directly.

The distance measuring unit 22 measures the distances from the wireless communication device 1 to the nearest object in the plurality of measurement directions in which measurement signals have been radiated according to the settings of antenna patterns stored in the setting storage unit 23.

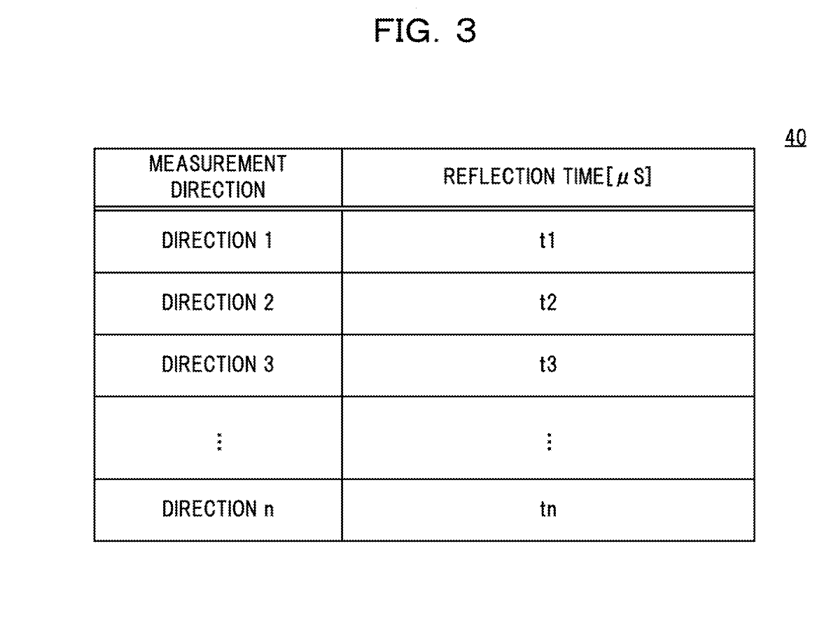

The distance measuring unit 22 stores the measurement results in a measured value table 40 stored in the measured value table storage unit 24. FIG. 3 is a first example configuration of a measured value table 40. The measured value table 40 stores reflection times t1, t2, t3, . . . , to tn measured in a plurality of measurement directions, directions 1, 2, 3, . . . , to n.

Referring back to FIG. 2, the antenna pattern determination unit 25 determines the antenna pattern of the directional antenna 10 to be used to perform a wireless communication, based on the measurement results stored in the measured value table 40. A method by which the antenna pattern determination unit 25 determines the antenna pattern will be described in an explanation of a method by which the wireless communication device 1 controls the directional antenna.

The appropriateness determination unit 26 determines the appropriateness of the directivity of the antenna pattern determined by the antenna pattern determination unit 25, based on communication quality instruction information received from the communication quality instruction acquisition unit 12. The control unit 27 generates a start command signal for starting an antenna control process including distance measurement and antenna pattern determination described above and provides the start command signal to the distance measurement unit 22 and antenna pattern determination unit 25. If the determination result made by the appropriateness determination unit 26 is “poor,” the control unit 27 provides a start command signal to the antenna pattern determination unit 25 to cause the antenna pattern determination unit 25 to determine another antenna pattern.

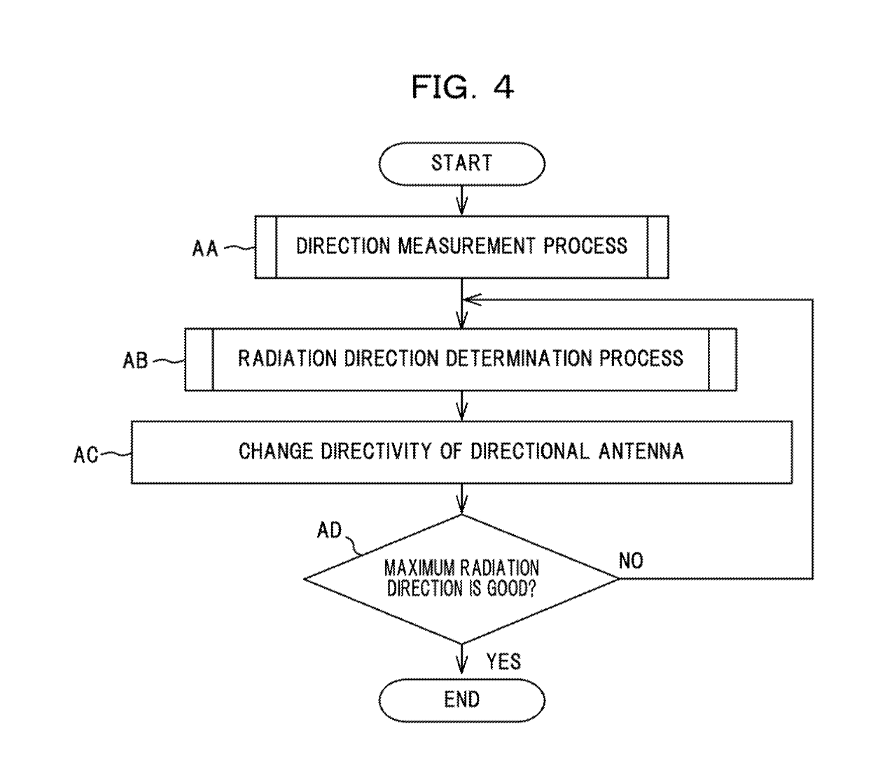

FIG. 4 is a first example of the directivity antenna control process. In other embodiments, the following operations AA to AD may be steps.

When the control unit 27 provides a start command signal to the distance measurement unit 22 and antenna pattern determination unit 25, an antenna control process is started. In the operation AA, the directional antenna 10, the directivity change unit 20, the measurement signal generation unit 21, and the distance measurement unit 22 measure the distances from the wireless communication device 1 to the nearest object in a plurality of measurement directions.

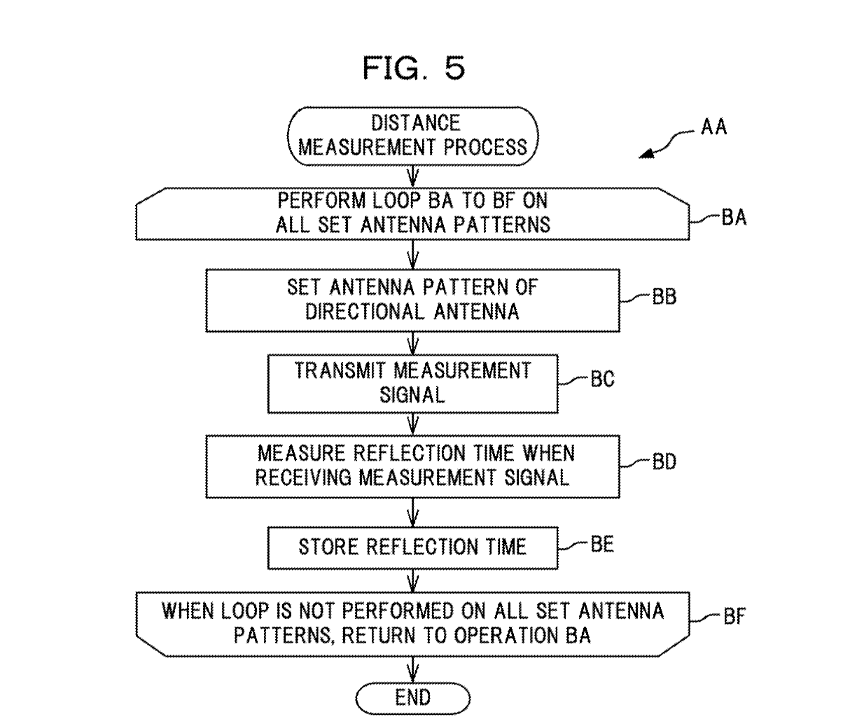

FIG. 5 is a first example of a distance measurement process AA. In other embodiments, the following operations BA to BF may be steps.

Loop BA to BF is performed according to the settings of antenna pattern stored in the setting storage unit 23.

In the operation BB, the distance measuring unit 22 sets the antenna pattern of the directional antenna 10 using the directivity change unit 20 according to the settings of antenna patterns stored in the setting storage unit 23, so as to change the directivity of the directional antenna 10.

In the operation BC, the measurement signal generation unit 21 provides measurement signals to the directional antenna 10. The directional antenna 10 transmits the measurement signals in the measurement directions determined by the settings of the antenna patterns.

In the operation BD, the distance measurement unit 22 measures the reflection times over which the measurement signals are transmitted by the directional antenna 10, reflected by the nearest object, and received by the directional antenna 10 again. The measurement signals generated by the measurement signal generation unit 21 may include unique patterns. The distance measurement unit 22 may measure the reflection times by obtaining the differences between the times when measurement signals including random patterns are transmitted and the times when the reflected measurement signals are received and detected. The measurement signals may be considered random. The distance measurement unit 22 may measure the reflection times by previously storing the measurement signals and obtaining correlations between the stored measurement signals and the reflected measurement signals.

In the operation BE, the distance measurement unit 22 stores the measured reflection times in the measured value table 40. After performing the loop BA to BF according to the settings of the antenna patterns stored in the setting storage unit 23, the process is ended.

Referring back to FIG. 4, in the operation AB, the antenna pattern determination unit 25 determines the beam radiation direction of the directional antenna 10.

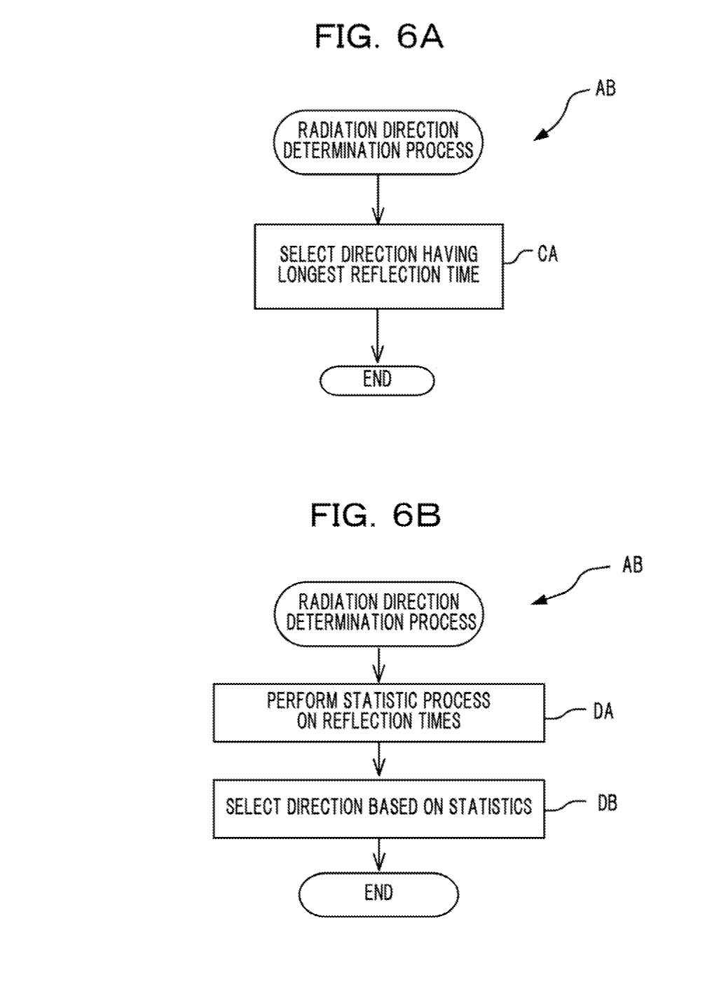

FIG. 6A represents a first example of the radiation direction determination process AB. In other embodiments, the following operation CA may be a step. In the operation CA, the antenna pattern determination unit 25 determines the direction in which, of the reflection times stored in the measured value table 40, the longest reflection time has been measured, as the beam radiation direction of the directional antenna 10.

At that time, the antenna pattern determination unit 25 may select the direction in which the longest of the reflection times shorter than a specified upper limit has been measured. Setting the upper limit of the reflection time may avoid improperly determining a direction in which the reflection signal of a measurement signal transmitted in a certain direction is not received, as the beam radiation direction.

FIG. 6B represents a second example of the radiation direction determination process AB. In other embodiments, the following operations DA and DB may be steps. In the operation DA, the antenna pattern determination unit 25 calculates statistics by performing a specified statistic process on the reflection times measured in the measurement directions stored in the measured value table 40.

The statistic process may be, for example, a process of calculating, as statistics, the averages of the reflection times and other reflection times measured in measurement directions close to the measurement directions of the former reflection times. Alternatively, the statistic process may be a process of smoothing variations in the reflection times measured in the measurement directions stored in the measured value table 40. Such a statistic process may reduce the influence of protrusions, recesses, or the like that exist locally.

In the operation DB, the antenna pattern determination unit 25 determines the direction having the longest statistically processed reflection time, as the beam radiation direction of the directional antenna 10. At that time, the antenna pattern determination unit 25 may select the direction in which the longest of the reflection times shorter than a specified upper limit has been measured.

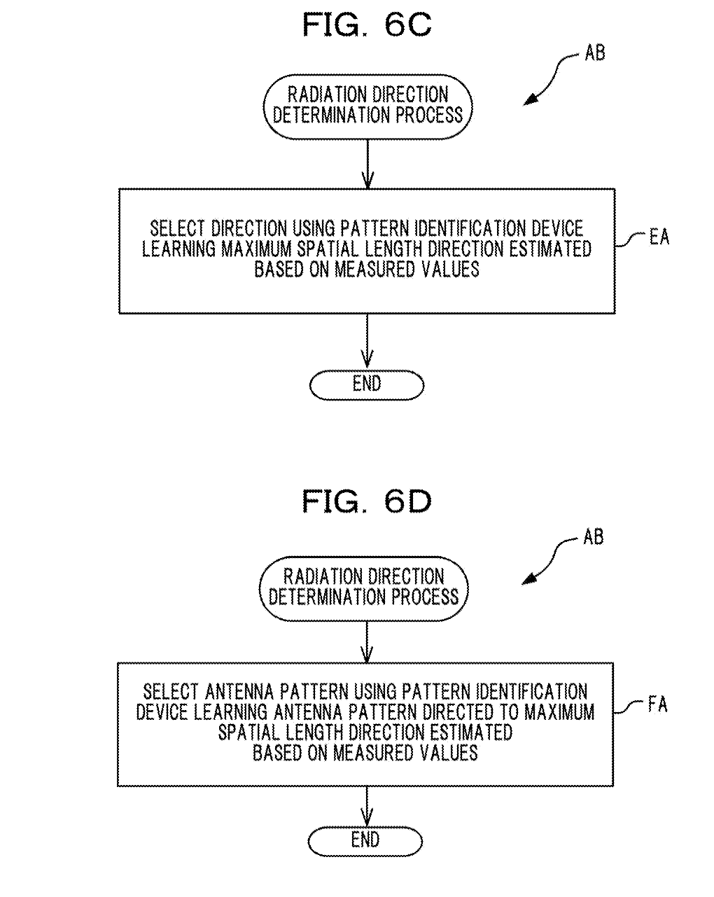

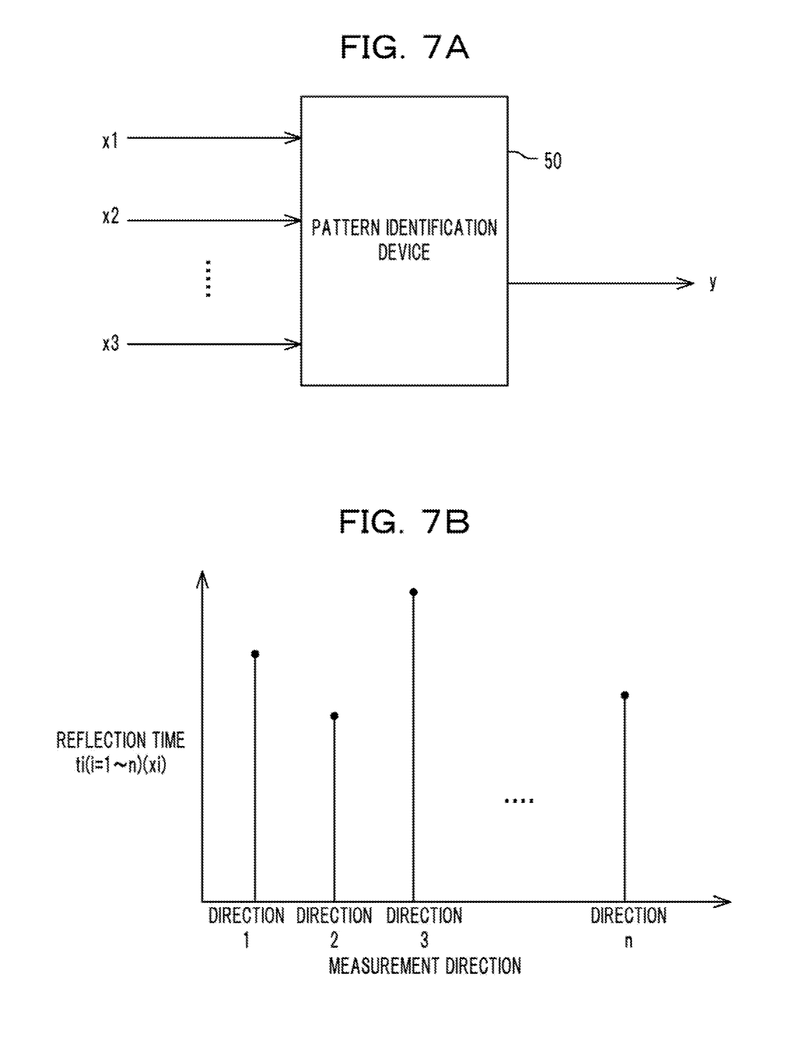

FIG. 6C represents a third example of the radiation direction determination process AB. In other embodiments, the following operation EA may be a step. In the operation EA, the antenna pattern determination unit 25 determines the beam radiation direction of the directional antenna 10 using a pattern identification device 50 as illustrated in FIG. 7A.

The pattern identification device 50 receives a set of input signals xi (i=1 to n) and outputs a class y to which a pattern of the set of the input signals xi belongs. The pattern identification device 50 according to this embodiment obtains a set of reflection times ti (i=1 to n) measured in measurement directions i stored in the measured value table 40, as a set of input signals xi. FIG. 7B is a graph schematically illustrating such input signals.

The pattern identification device 50 outputs, as a class y, a direction in which the spatial length from the wireless communication device 1 to the nearest object is longest. In the following explanation, the “direction in which the spatial length from the wireless communication device 1 to the nearest object is longest” may be referred to as “maximum spatial length direction.” The pattern identification device 50 as described above may be realized by a neural network, support vector machine (SVM), k-nearest neighbor classifier, or Bayes classifier. The pattern identification device 50 previously learns the maximum spatial length direction estimated based on the reflection times ti measured in the measurement directions i, according to machine learning. Use of the pattern identification device 50 allows selecting a direction between adjacent measurement directions as the maximum spatial length direction even when the maximum spatial length direction does not match any of the measurement directions i.

Alternatively, a pattern identification device 50 may be used that outputs, as a class y, an identifier of the antenna pattern which radiates beams in the maximum spatial length direction, instead of the maximum spatial length direction. FIG. 6D illustrates an example of the radiation direction determination process AB using the identifier. FIG. 6D is a diagram illustrating a fourth example of the radiation direction determination process AB. In other embodiments, the following operation FA may be a step.

In the operation FA, the antenna pattern determination unit 25 inputs a set of the reflection times ti measured in the measurement directions i to the pattern identification device 50 and obtains, from the pattern identification device 50, an antenna pattern that radiates beams in the maximum spatial length direction. The antenna pattern determination unit 25 determines the antenna pattern obtained from the pattern identification device 50 as the antenna pattern of the directional antenna 10. The pattern identification device 50 previously learns the antenna pattern that radiates beams in the maximum spatial length direction estimated based on the reflection times ti measured in the measurement directions i, according to mechanical learning.

Referring back to FIG. 4, in the operation AC, the antenna pattern determination unit 25 determines the radiation direction determined in the operation AB, as the antenna pattern of the directional antenna 10 for radiating beams. When selecting the identifier of the antenna pattern for radiating beams in the maximum spatial length direction using the pattern identification device 50 as in the radiation direction determination process AB of FIG. 6D, the selected antenna pattern is used. The directivity change unit 20 changes the directivity of the directional antenna 10 by changing the antenna pattern of the directional antenna 10 to radiate beams using the determined antenna pattern.

In the operation AD, the appropriateness determination unit 26 determines the appropriateness of the directivity of the current antenna pattern in accordance with communication quality indicating information received from the communication quality indicating information obtaining unit 12. The appropriateness determination unit 26 outputs an appropriateness determination signal to the control unit 27. If the directivity of the antenna pattern is good (Y in operation AD), the antenna control unit 13 ends the process.

When the directivity of the antenna pattern is “poor” (N in operation AD), the control unit 27 provides a start command signal to the antenna pattern determination unit 25 to return the process to the operation AB. Upon receipt of the start command signal, the antenna pattern determination unit 25 determines an antenna pattern that radiates beams in a direction different from the direction of the previously determined pattern, as the beam radiation direction of the directional antenna 10. For example, when first performing the operation AB, the antenna pattern determination unit 25 determines a plurality of antenna pattern candidates in such a manner that the candidates are assigned priorities. If it is determined that a certain candidate is “poor,” the antenna pattern determination unit 25 may determine a candidate having the second highest priority, as the antenna pattern.

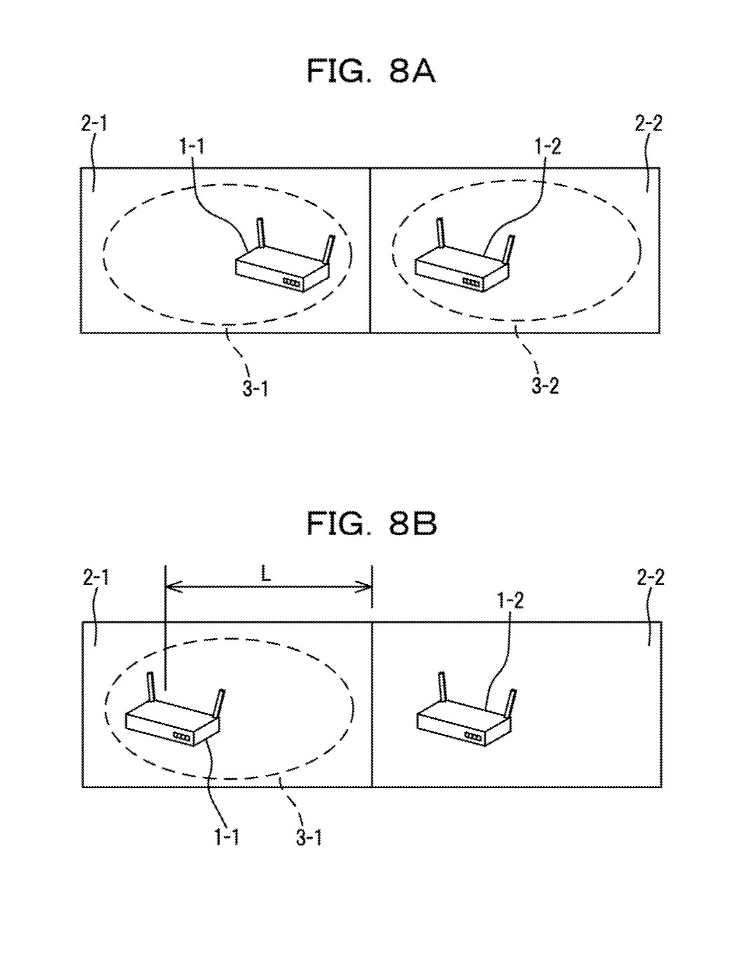

In this embodiment, the directional antenna 10 radiates beams in the direction in which the spatial length from the wireless communication device 1 to the nearest object is longest. Thus, when the wireless communication devices 1 are disposed in rooms, beams are directed in a direction in which the distance from each wireless communication device 1 to a wall is longest, for example, in a direction in which wider space exists when seen from each wireless communication device 1, as illustrated in FIG. 8A. In FIGS. 8A and 8B, reference numerals 1-1 and 1-2 represent wireless communication devices according to this embodiment. Reference numerals 2-1 and 2-2 represent the rooms where the wireless communication devices 1-1 and 1-2 are disposed. Reference numerals 3-1 and 3-2 represent the ranges that radio waves transmitted from the wireless communication devices 1-1 and 1-2 reach.

When the wireless communication devices 1-1 and 1-2 are disposed adjacent to a wall, the devices radiate directional beams in directions different from the directions toward the adjacent wall. Thus, even when the wireless communication devices 1-1 and 1-2 are disposed adjacent to each other with the wall therebetween, the reach ranges 3-1 and 3-2 of radio waves transmitted from the wireless communication devices 1-1 and 1-2 may not overlap each other. This may reduce degradation in communication quality caused by interference between radio signals.

FIG. 8B illustrates a case where another wireless communication device, 1-2, is present in the direction in which the wireless communication device 1-1 radiates beams. The direction in which the wireless communication device 1-1 radiates beams is a direction in which a distance L from the interface 1-1 to the nearest wall is longest. Thus, the wireless communication device 1-1 may maximize the distance from itself to the adjacent room present in the beam radiation direction by using the space of the room 2-1 where the wireless communication device 1-1 is disposed. As seen, even in a case as illustrated in FIG. 8B, there is obtained an advantageous effect of reducing interference between the wireless communication device 1-1 and another wireless communication device, 1-2, disposed in the adjacent room.

The wireless communication device 1 according to this embodiment radiates radio waves in the direction in which wider space is present when seen from the wireless communication device 1. This allows restraining radiation of energy in unnecessary directions and thus saving power consumption. Also, the wireless communication device 1 may automatically determine the direction of the directional antenna 10. This reduces man-hours and/or installation costs required to install the wireless communication device 1.

There are cases where a reflection signal of a measurement signal transmitted in a certain direction is not readily received, such as a case where the room has a window and a case where there is an object that does not readily reflect a measurement signal. As described in the explanation of the operations CA and DB of FIG. 6, setting the upper limit of the reflection times of measurement signals may reduce if not avoid the setting of an improper radiation direction when the reflection signal of a measurement signal is not received.

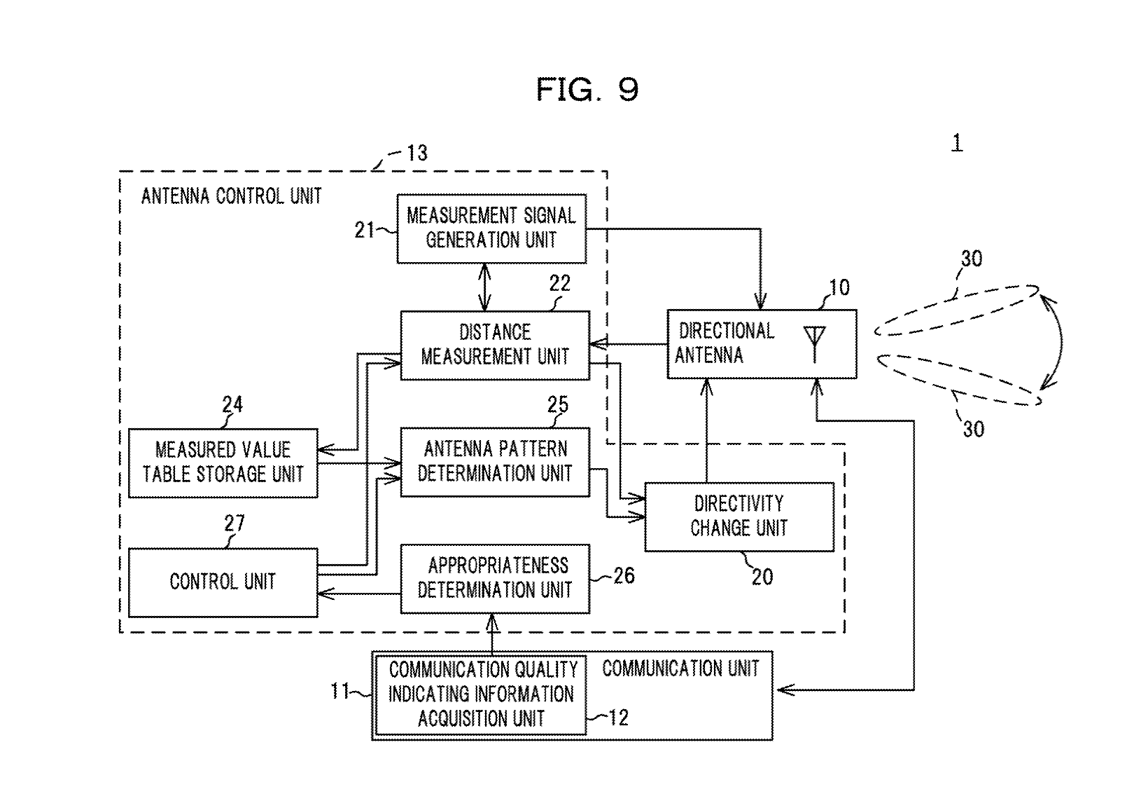

FIG. 9 is a diagram schematically illustrating a configuration of a wireless communication device according to a second embodiment. In this embodiment, in measuring the distance from the wireless communication device 1 to the nearest object, the distance to the nearest object is measured in a plurality of directions while sweeping the beam radiation direction in the horizontal direction and/or vertical direction. In this configuration, the setting storage unit 23 illustrated in FIG. 2 may be omitted.

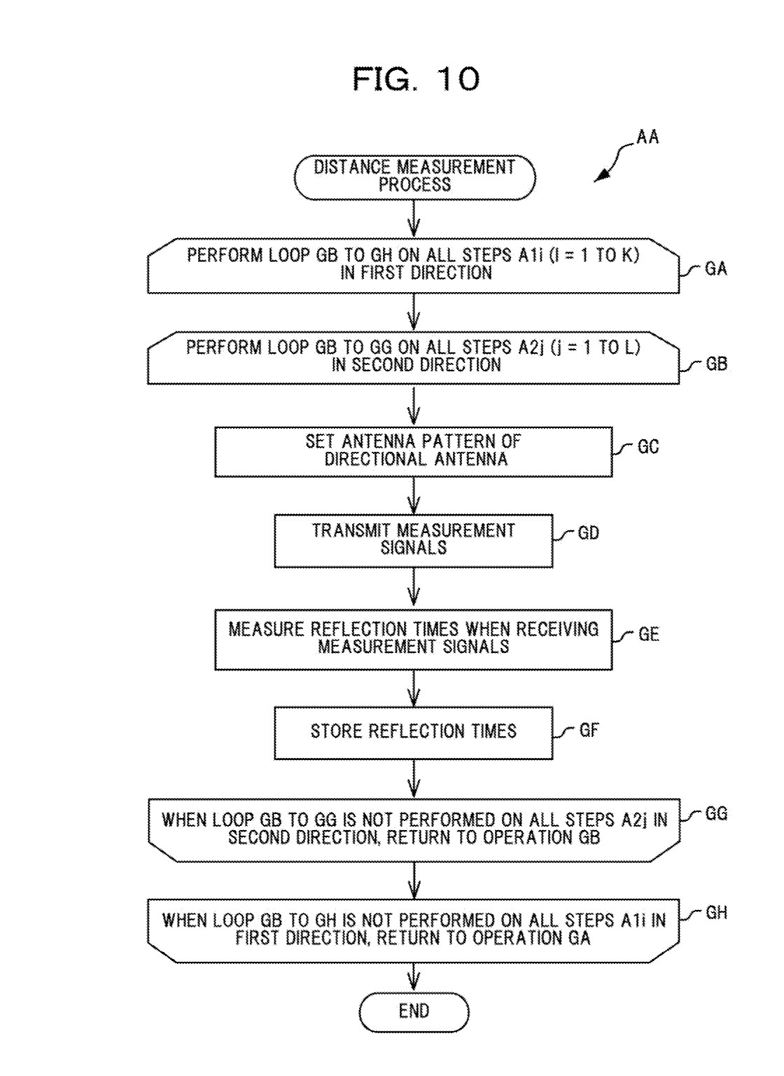

FIG. 10 illustrates a second example of the distance measurement process AA which is performed by the wireless communication device 1 of FIG. 9. In other embodiments, the following operations GA to GH may be steps. A loop from GA to GH is performed with respect to all step angles A1i (i=1 to K) provided in a first direction, which is one of the horizontal and vertical directions. A loop from GB to GG is performed with respect to all step angles A2j (j=2 to L) provided in a second direction, which is the other of the horizontal and vertical directions.

The distance measurement unit 22 sweeps the beam radiation direction in the horizontal direction and/or vertical direction by repeating the operations GC to GF while changing the beam radiation direction to a direction determined by a set of two angles (A1i, A2j) determined with respect to the first and second directions. The step width for sweeping the beam radiation direction may be a fixed value. The distance measurement unit 22 may control the step width variably. For example, the distance measurement unit 22 may control the step width in such a manner that the step width is reduced when the measurement distance significantly varies with a change in measurement direction and the step width is increased when the measurement distance slightly varies.

In the operation GC, the distance measurement unit 22 causes the directivity change unit 20 to set the antenna pattern so that the directional antenna 10 radiates beams in a direction determined by the set of angles (Ali, A2i). The processes of the operations GD to GF are similar to those of the operations BC to BE described referring to FIG. 5. The loop from GB to GG and loop from GA to GH are performed with respect to the angles A2j and A1i in the second and first directions and then the process is completed.

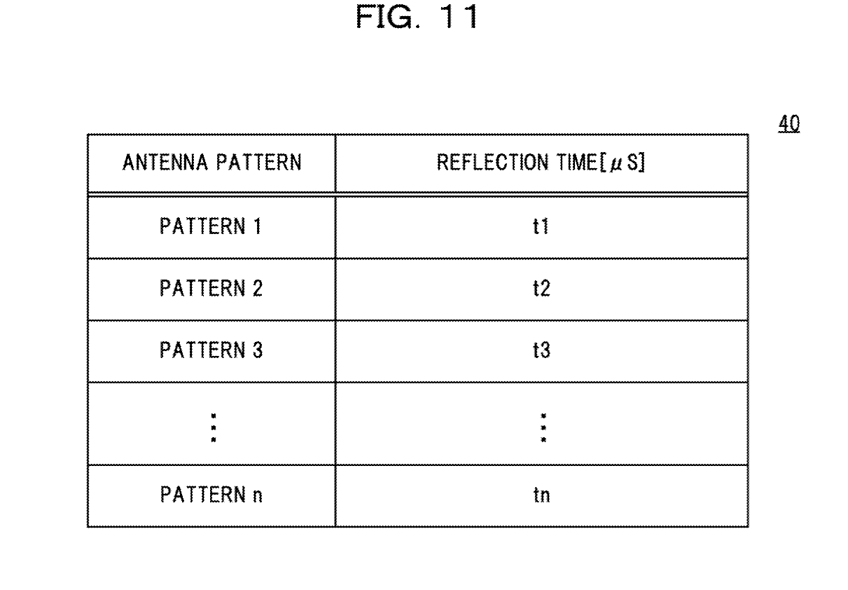

FIG. 11 is a second example configuration of the measured value table 40. Instead of a plurality of measurement directions, the measured value table 40 stores the identifiers, patterns 1 . . . to n, of a plurality of antenna patterns for radiating beams in a plurality of measurement directions, and reflection times t1 . . . to tn measured when radiating beams using the antenna patterns.

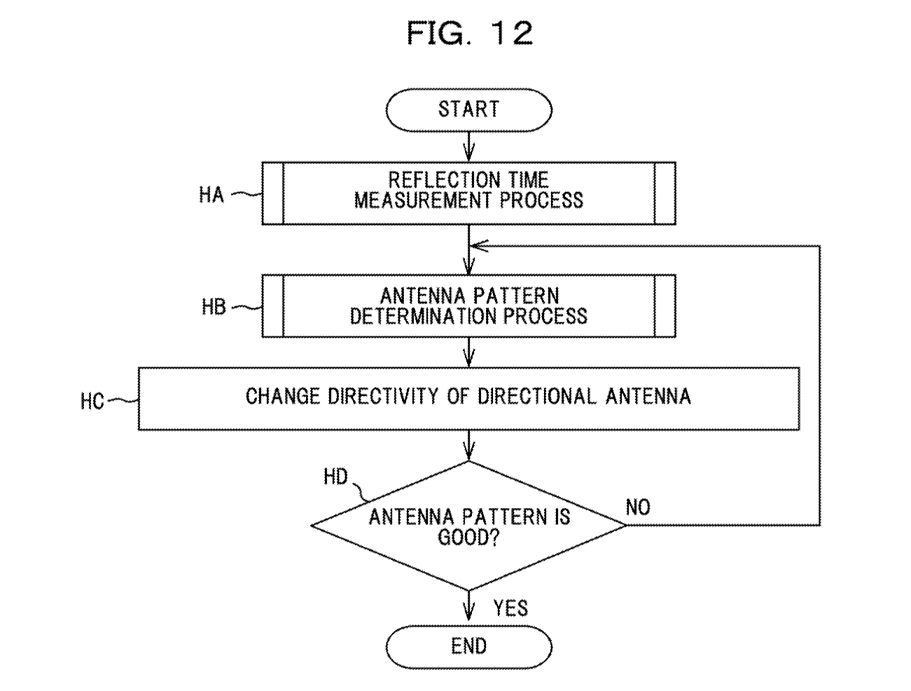

FIG. 12 is a second example of the process of the directional antenna control method. This control method is used to use the measured value table illustrated in FIG. 11. In other embodiments, the following operations HA to HD may be steps.

When the control unit 27 provides a start command signal to the distance measurement unit 22 and antenna pattern determination unit 25, an antenna control process is started. In the operation HA, the directional antenna 10, directivity change unit 20, measurement signal generation unit 21, and distance measurement unit 22 measure the reflection times when radiating beams using the plurality of antenna patterns for radiating beams in a plurality of measurement directions.

The reflection time measurement process of the operation HA may be similar to the distance measurement processes BA to BF of FIG. 5 or the distance measurement processes GA to GH of FIG. 10. However, in the operation BE of FIG. 5, the distance measurement unit 22 stores the set of the identifiers of the antenna patterns, whose settings are stored in the setting storage unit 23, and the reflection times measured when radiating beams using these antenna patterns.

Also, in measuring the reflection times as in the distance measurement processes GA to GH of FIG. 10, different antenna patterns are assigned to sets of two angles (A1i, A2j) determined with respect to the first and second directions. In the operation GF of FIG. 10, the distance measurement unit 22 stores, in the measured value table 40, sets of the identifiers of antenna patterns corresponding to the sets of two angles (A1i, A2j) and the reflection times of beams radiated using the antenna patterns.

In the operation HB, the antenna pattern determination unit 25 determines the antenna pattern of the directional antenna 10.

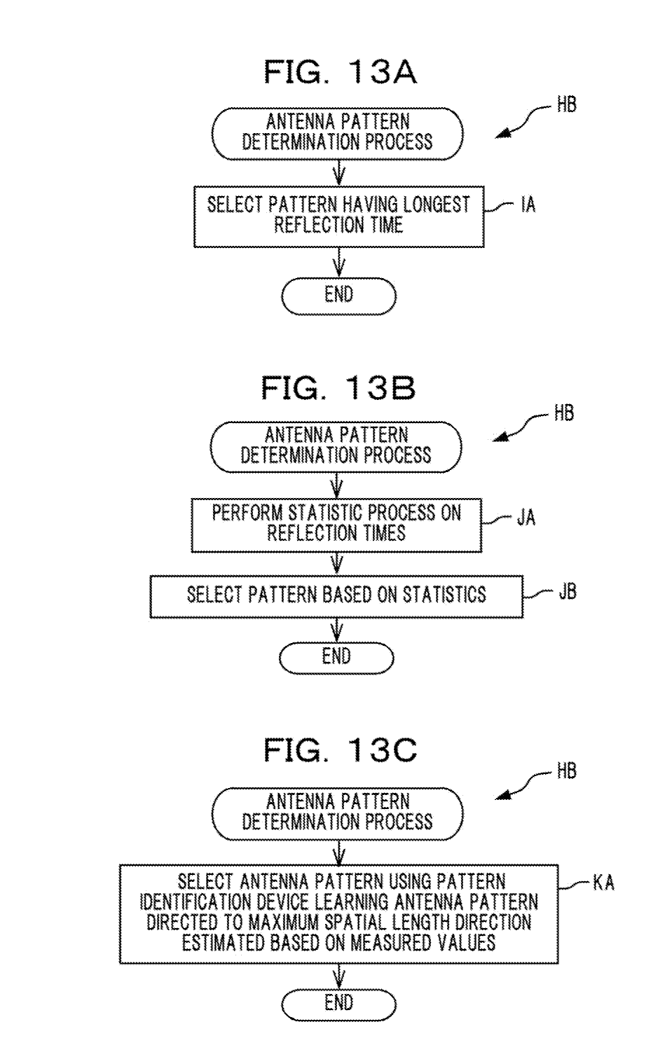

FIG. 13A is a first example of the antenna pattern determination process HB. In other embodiments, the following operation IA may be a step. In the operation IA, the antenna pattern determination unit 25 determines an antenna pattern with respect to which the longest among the reflection times stored in the measured value table 40 has been measured, as the antenna pattern of the directional antenna 10. At that time, the antenna pattern determination unit 25 may select an antenna pattern with respect to which the longest of the reflection times shorter than a specified upper limit has been measured.

FIG. 13B is a second example of the antenna pattern determination process HB. In other embodiments, the following operations JA and JB may be steps. In the operation JA, the antenna pattern determination unit 25 calculates statistics by performing a specified statistic process on the reflection times measured in the measurement directions stored in the measured value table 40.

The statistic process may be, for example, a process of calculating, as statistics, the averages of the reflection times and other reflection times measured when radiating beams using antenna patterns for radiating beams in directions close to the directions of the antenna patterns used in measuring the former reflection times. Alternatively, the statistic process may be a process of smoothing variations in the reflection times measured in the measurement directions stored in the measured value table 40.

In the operation JA, the antenna pattern determination unit 25 determines an antenna pattern with respect to which the longest of the statistically processed reflection times has been obtained, as the antenna pattern of the directional antenna 10. At that time, the antenna pattern determination unit 25 may select an antenna pattern with respect to which the longest of the reflection times shorter than a specified upper limit has been obtained.

FIG. 13C is a third example of the antenna pattern determination process HB. In other embodiments, the following operation KA may be a step. In the operation KA, the antenna pattern determination unit 25 determines the antenna pattern of the directional antenna 10 using the pattern identification device 50 as illustrated in FIG. 7A.

The pattern identification device 50 used here obtains a set of reflection times ti (i=1 to n) measured when radiating beams using patterns i (i=1 to n) stored in the measured value table 40, as a set of input signals xi. The pattern identification device 50 outputs an antenna pattern that radiates beams in the maximum spatial length direction, as a class y. The antenna pattern determination unit 25 determines the antenna pattern outputted from the pattern identification device 50, as the antenna pattern of the directional antenna 10. The pattern identification device 50 previously learns the antenna pattern that radiates beams in the maximum spatial length direction estimated based on reflection times ti measured using patterns n, according to mechanical learning.

Referring back to FIG. 12, in the operation HC, the directivity change unit 20 changes the directivity of the directional antenna 10 by changing the antenna pattern of the directional antenna 10 so that beams are radiated using the antenna pattern determined in the operation HC.

In the operation HD, the appropriateness determination unit 26 determines the appropriateness of the directivity of the current antenna pattern. If the directivity of the antenna pattern is “good” (Y in operation HD), the antenna control unit 13 ends the process. If the directivity of the antenna pattern is “poor” (N in operation HD), the control unit 27 provides a start command signal to the antenna pattern determination unit 25 to return the process to the operation HB. Upon receipt of the start command signal, the antenna pattern determination unit 25 determines an antenna pattern that radiates beams in a direction different from the direction of the previously determined pattern, as the beam radiation direction of the directional antenna 10.

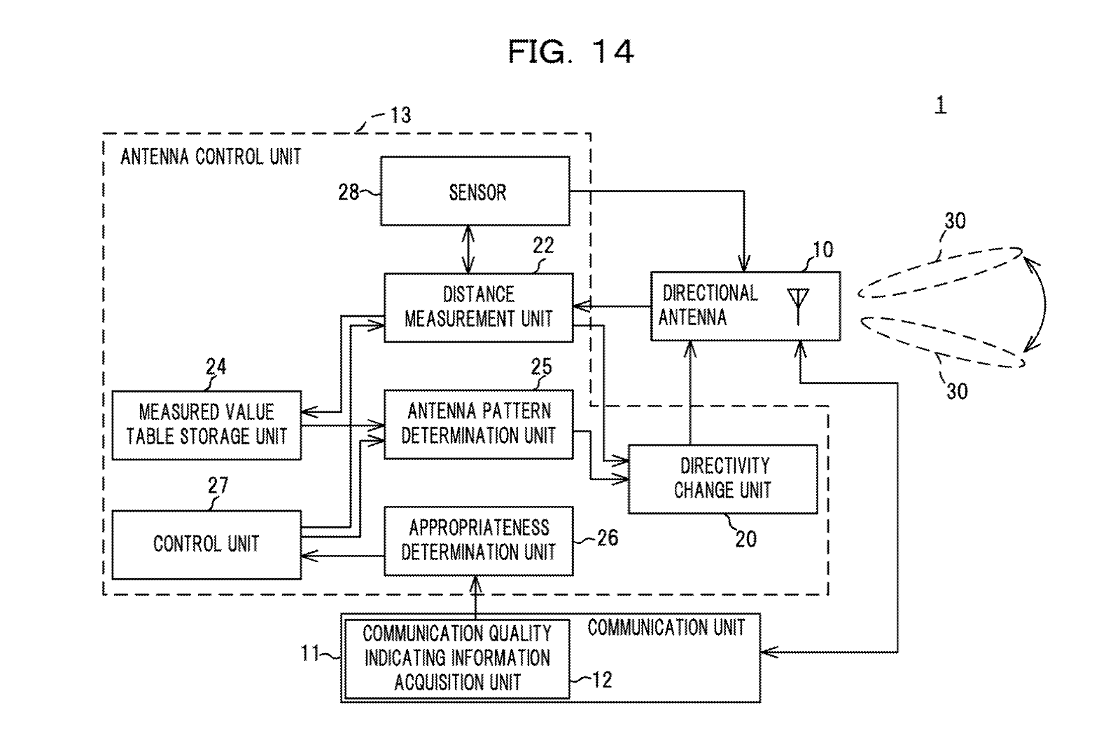

FIG. 14 is a diagram schematically illustrating a configuration of a wireless communication device according to a third embodiment. In this embodiment, the antenna control unit includes a sensor 28 that is a distance measuring sensor for measuring the spatial lengths from the wireless communication device 1 to the nearest object in a plurality of directions. The distance measurement unit 22 measures the spatial lengths from the wireless communication device 1 to the nearest object in a plurality of directions using the sensor 28.

For example, the sensor 28 is a distance measuring sensor that detects the distance from the sensor 28 to the nearest object present in the radiation direction of a measurement signal, based on the reflection time over which light, such as infrared rays or electromagnetic waves, is transmitted as a measurement signal by the sensor 28, reflected by the nearest object, and returns to the sensor 28 again. Also, for example, the sensor 28 may be a distance measuring sensor that detects the distance from the sensor 28 to the nearest object present in the radiation direction of a measurement signal, based on the reflection time over which sound such as ultrasound is transmitted by the sensor 28 as the measurement signal, reflected by the nearest object, and returns to the sensor 28 again. Since the reflection time itself is proportionate to the distance to the nearest object, the distance measuring unit 22 may handle the reflection time itself as information indicating the distance.

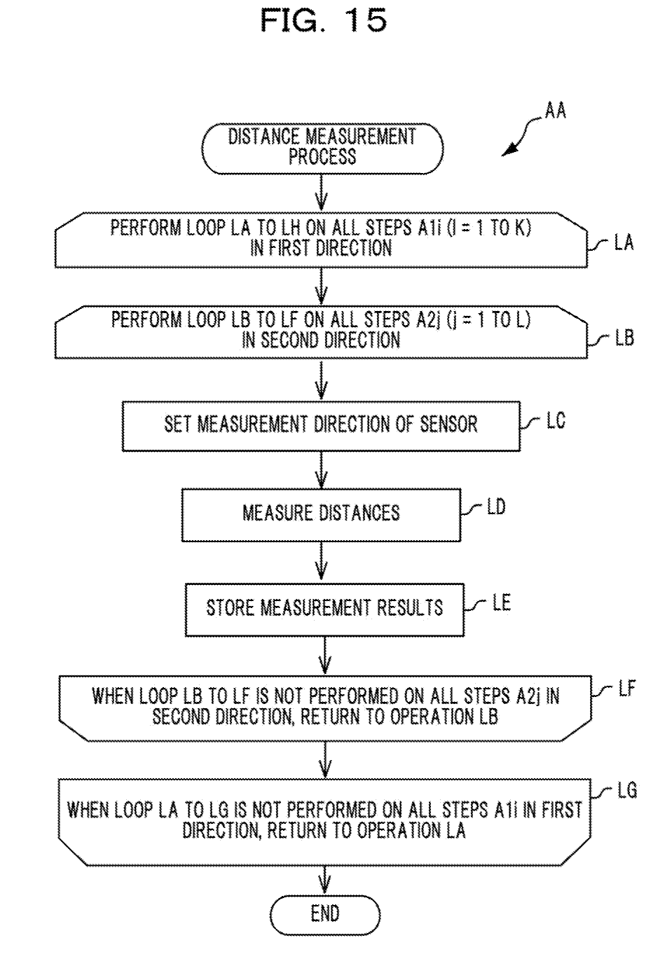

A directional antenna control method that the wireless communication device 1 of FIG. 14 performs may be similar to that illustrated in FIG. 4. FIG. 15 illustrates a third example of the distance measurement process AA, which is performed by the wireless communication device 1 of FIG. 14. In other embodiments, the following operations LA to LG may be steps.

A loop from LA to LH is performed with respect to all step angles A1i (i=1 to K) provided in a first direction, which is one of the horizontal and vertical directions. A loop LB to LF is performed with respect to all step angles A2j (j=1 to L) provided in a second direction, which is the other of the horizontal and vertical directions.

In the operation LC, the distance measurement unit 22 sets the measurement direction of the sensor 28 to a direction determined by a set of two angles (A1i, A2j) determined with respect to the first and second directions. As seen, the distance measurement unit 22 sweeps the measurement direction of the distance in the horizontal direction and/or vertical direction by repeating the operations LC to LE while changing the measuring direction of the sensor 28. The step width for sweeping the measuring direction of the sensor 28 may be a fixed value. The distance measurement unit 22 may control the step width variably. For example, the distance measurement unit 22 may control the step width in such a manner that the step width is reduced when the measurement distance significantly varies with a change in measurement direction and the step width is increased when the measurement distance slightly varies.

In the operation LD, the distance measurement unit 22 measures the reflection time over which a measurement signal is transmitted by the sensor 28, reflected by the nearest object, and received by the sensor 28 again. In the operation LE, the distance measurement unit 22 stores the measured reflection times in the measured value table 40. The configuration of the measured value table 40 may be similar to that illustrated in FIG. 3.

The loop from LB to LF and the loop from LA to LG are performed with respect to the angles A2j and A1i in the second and first directions and then the process is completed.

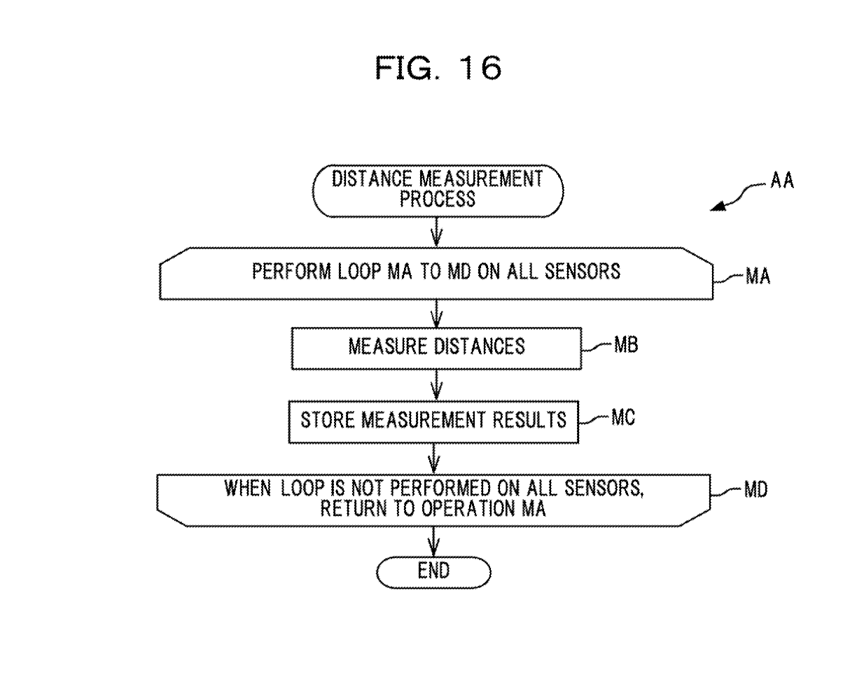

Referring back to FIG. 14, the sensor 28 may include a plurality of sensors i (i=1 to n) for measuring the spatial lengths from the wireless communication device 1 to the nearest object in a plurality of directions i (i=1 to n). FIG. 16 illustrates a fourth example of the distance measurement process AA, where the above-mentioned plurality of sensors i are used. In other embodiments, the following operations MA to MD may be steps.

A loop from MA to MD is performed with respect to each of the plurality of sensors i (i=1 to n). In the operation MB, the distance measurement unit 22 measures the reflection times over which measurement signals are transmitted by the sensors i, reflected by the nearest object, and received by the sensors i.

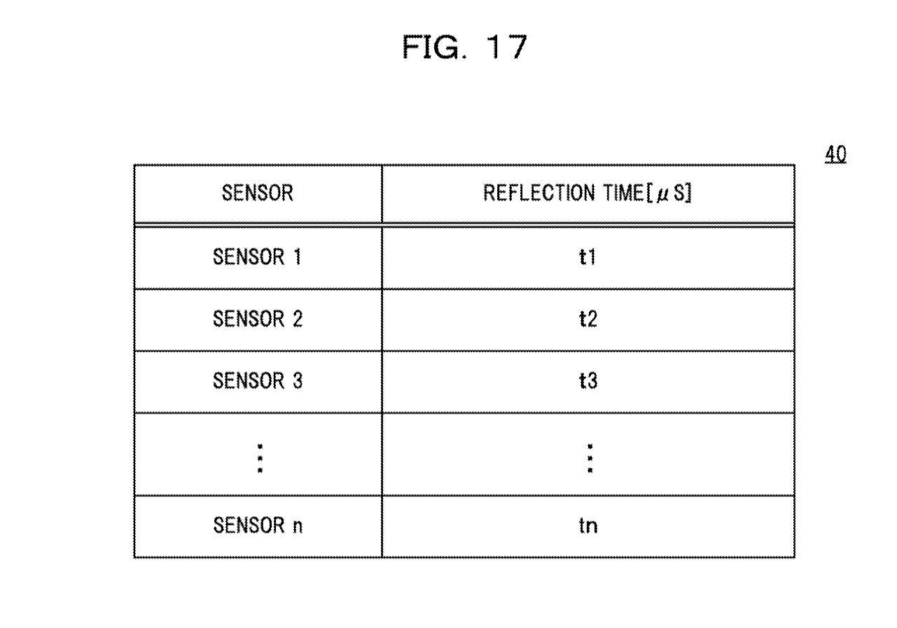

In the operation MC, the measurement signal generation unit 22 stores the measured reflection times in the measured value table 40. FIG. 17 represents a third example configuration of the measured value table 40. The measured value table 40 stores the reflection times ti (i=1 to n) measured by the plurality of sensors i (i=1 to n). The loop from MA to MD is performed with respect to all the sensors i and then the process is completed.

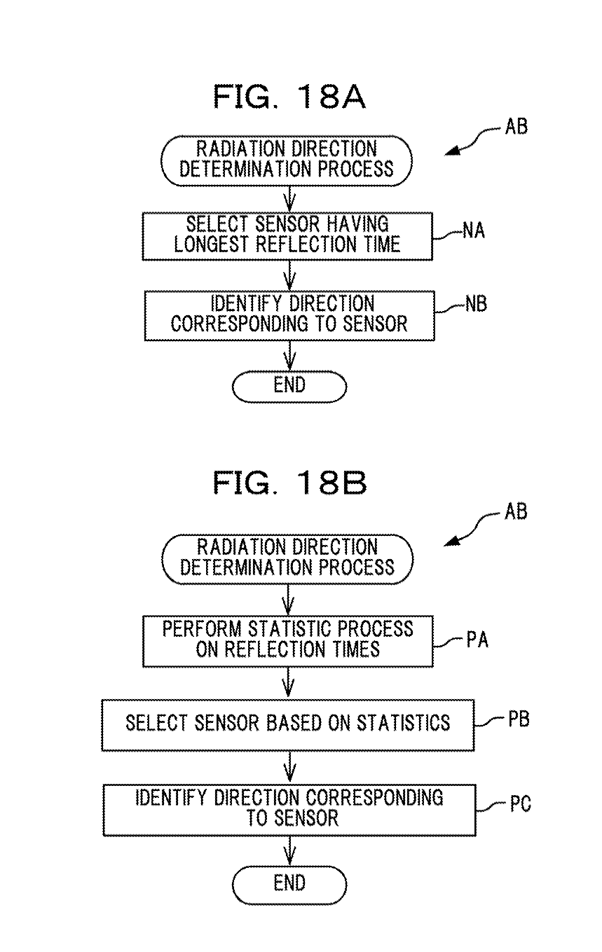

FIG. 18A illustrates a fifth example of the radiation direction determination process AB, where the above-mentioned plurality of sensors i are used. In other embodiments, the following operations NA and NB may be steps. In the operation NA, the antenna pattern determination unit 25 selects a sensor with respect to which the longest of the reflection times stored in the measured value table 40 has been measured. At that time, the antenna pattern determination unit 25 may select a sensor with respect to which the longest of the reflection times shorter than a specified upper limit has been measured.

In the operation NB, the antenna pattern determination unit 25 determines the measuring direction of the sensor selected in the operation NA, as the beam radiation direction of the directional antenna 10.

FIG. 18B illustrates a sixth example of the radiation direction determination process AB, where the above-mentioned plurality of sensors i are used. In other embodiments, the following operations PA to PC may be steps.

In the operation PA, the antenna pattern determination unit 25 calculates statistics by performing a specified statistic process on the reflection times measured in the measurement directions stored in the measured value table 40. The statistic process may be, for example, a process of calculating, as statistics, the averages of the reflection times measured by sensors having adjacent measurement directions among the sensors. Alternatively, the statistic process may be a process of smoothing variations in the reflection times that are stored in the measured value table 40 and have been measured by the sensors.

In the operation PB, the antenna pattern determination unit 25 selects a sensor having the longest of the statistically processed reflection times. At that time, the antenna pattern determination unit 25 may select a sensor with respect to which the longest of the reflection times shorter than a specified upper limit has been measured. In the operation PC, the antenna pattern determination unit 25 determines the measurement direction of the sensor selected in the operation PB, as the beam radiation direction of the directional antenna 10.

The antenna pattern determination unit 25 may determine the beam radiation direction of the directional antenna 10 using a pattern identification device 50 similar to that used in the radiation direction determination process AB of FIG. 6C. The pattern identification device 50 described above obtains a set of reflection times ti (i=1 to n) that are stored in the measured value table 40 and have been measured by the sensors i, as a set of input signals xi. The pattern identification device 50 outputs the maximum spatial length direction, as a class y. The pattern identification 50 previously learns the maximum spatial length direction estimated based on the reflection times ti measured by the sensors i.

Alternatively, the antenna pattern determination unit 25 may determine the antenna pattern of the directional antenna 10 using a pattern identification device 50 similar to that used in the radiation direction determination process AB of FIG. 6D. The pattern identification device 50 obtains a set of reflection times ti (i=1 to n) that are stored in the measured value table 40 and have been measured by the sensors i, as a set of input signals xi. The pattern identification device 50 outputs the identifier of the antenna pattern that radiates beams in the maximum spatial length direction, as a class y. The pattern identification device 50 previously learns the antenna pattern that radiates beams in the maximum spatial length direction estimated based on the reflection times ti measured by the sensors i, according to mechanical learning.

The above-mentioned embodiment suppresses interference between a plurality of wireless communication devices disposed indoors.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication device comprising:
a directional antenna that transmits radio signals; and
an antenna control unit that measures, in a plurality of directions, spatial lengths from the wireless communication device to an object nearest the wireless communication device, and directs a directional antenna beam radiation direction toward a direction having the longest of the measured spatial lengths, when transmitting the radio signals.

2. The wireless communication device according to claim 1, wherein
the antenna control unit includes a distance measuring unit that measures the spatial lengths in the plurality of directions, based on reflection times of radio waves transmitted from the directional antenna in different directional antenna beam radiation directions.

3. The wireless communication device according to claim 1, wherein
the antenna control unit includes a distance measuring unit that measures the spatial lengths in the plurality of directions, based on reflection times of one of electromagnetic waves and sound waves transmitted from a sensor in the plurality of directions.

4. The wireless communication device according to claim 1, wherein
the antenna control unit determines the directional antenna beam radiation direction based on a spatial length shorter than a specified upper limit among the measured spatial lengths.

5. A wireless communication device comprising:
a directional antenna that transmits radio signals; and
an antenna control unit that, based on respective reflection times of radio waves transmitted from the directional antenna in different beam radiation directions, directs a directional antenna beam radiation direction toward a direction in which a spatial length from the wireless communication device to an object nearest the wireless communication device is the longest, when transmitting radio signals.

6. The wireless communication device according to claim 5, wherein
the antenna control unit determines the directional antenna beam radiation direction based on a reflection time shorter than a specified upper limit among the reflection times.

7. The wireless communication device according to claim 1, further comprising
an appropriateness determination unit that determines appropriateness of the directional antenna beam radiation direction determined by the antenna control unit, based on communication quality of wireless communication performed using the directional antenna.

8. A method for controlling a directional antenna of a wireless communication device, the directional antenna transmitting radio signals, the method comprising:
measuring spatial lengths from the wireless communication device to an object nearest the wireless communication device in a plurality of directions,
directing a directional antenna beam radiation direction toward a direction having the longest of the measured spatial lengths, when the radio signals are transmitted.
